(19) United States
(12) Patent Application Publication
(10) Pub. No.: US 2026/0245982 A1
(43) Pub. Date: Aug. 20, 2026

(54) BATTERY TRAY LEAK DETECTION AND ISOLATION

(71) Applicant: GM Global Technology Operations LLC, Detroit, MI (US)

(72) Inventors: Hassan Ghassemi-Armaki, Northville, MI (US); Blair E. Carlson, Ann Arbor, MI (US); Randolph Zeitvogel, Beverly Hills, MI (US)

(21) Appl. No.: 19/058,252

(22) Filed: Feb. 20, 2025

(51) Int. Cl. H01M 10/42; G01M 3/24

(52) U.S. Cl. CPC H01M 10/4228; G01M 3/24; H01M 10/4285

(57) ABSTRACT

A system for leak testing a battery tray includes a system controller, a testing cover adapted to be positioned onto a top surface of a battery tray and a top surface of an automated guided vehicle (AGV), a flange extending downward from the testing cover and providing a sealed engagement between the testing cover, the battery tray and the AGV, thereby defining an internal sealed chamber and an external sealed chamber therebetween, a testing gas supply module adapted to provide pressurized test gas into the external sealed chamber; and at least one of at least one first sensor in communication with the system controller and adapted to monitor a concentration of the test gas within the internal sealed chamber, and at least one microphone in communication with the system controller and adapted to monitor a sound pressure level within the internal sealed chamber.

### INTRODUCTION

The present disclosure relates to a method and system for leak testing a battery tray adapted to house a plurality of battery cells of a battery pack.

Battery trays are designed with a plurality of individual compartments, wherein, often, each compartment is adapted to house a single row of battery cells, including an electrolyte fluid. Current leak testing methods for battery trays involve a two-step process wherein first, robotic pass/fail testing identifies a leak within a battery tray, and second, the location of the leak(s) is identified through manual examination of the battery tray and the welds used to interconnect the various components thereof. Such processes are non-automated and labor intensive.

Thus, while current systems and methods of inspecting battery trays achieve their intended purpose, there is a need for a new and improved system and method for automatically leak testing a battery tray and providing detection of leaks within the battery tray and an initial indication of a location of any detected leaks within the battery tray.

### SUMMARY

According to several aspects of the present disclosure, a system for leak testing a battery tray includes a system controller, a testing cover adapted to be positioned, by the system controller, onto a top surface of a battery tray, a flange extending downward from the testing cover and adapted to provide a sealed engagement between the testing cover and both the top surface of the battery tray and a top surface of an automated guided vehicle (AGV) on which the battery tray is supported when the testing cover is positioned onto the top surface of the battery tray, thereby defining an internal sealed chamber and an external sealed chamber therebetween, a testing gas supply module, in communication with the system controller and adapted to provide pressurized test gas into the external sealed chamber, and at least one of at least one first sensor in communication with the system controller and adapted to monitor a concentration of the test gas within the internal sealed chamber, and at least one microphone in communication with the system controller and adapted to monitor a sound pressure level within the internal sealed chamber.

According to another aspect, the flange defines a plurality of testing compartments and when the flange is in sealed engagement with the top surface of the battery tray, the flange defines a corresponding plurality of individual internal sealed chambers therebetween.

According to another aspect, each one of the plurality of testing compartments includes at least one of at least one first sensor in communication with the system controller and adapted to monitor a concentration of the test gas within a corresponding one of the plurality of individual internal sealed chambers, and at least one microphone in communication with the system controller and adapted to monitor a sound pressure level within a corresponding one of the plurality of individual internal sealed chambers.

According to another aspect, the system further includes a human machine interface (HMI) in communication with the system controller and adapted to provide information to a user of the system and to allow the user of the system to provide input to the system controller.

According to another aspect, the system controller is adapted to collect data from each one of the at least one first sensor within each one of the plurality of individual internal sealed chambers, collect data from each one of the at least one microphone within each one of the plurality of individual internal sealed chambers, analyze the data collected from each one of the at least one first sensor within each one of the plurality of individual internal sealed chambers and each one of the at least one microphone within each one of the plurality of individual internal sealed chambers, and identify leaks within each one of the individual internal sealed chambers and a specific location of each detected leak based on the data collected from each one of the at least one first sensor within each one of the plurality of individual internal sealed chambers and each one of the at least one microphone within each one of the plurality of individual internal sealed chambers.

According to another aspect, each one of the at least one first sensor within each one of the plurality of individual internal sealed chambers is a photoacoustic spectrometry carbon-dioxide (PAS CO2) sensor and the test gas is carbon-dioxide gas.

According to another aspect, each one of the at least one microphone within each one of the plurality of individual internal sealed chambers is an ultrasonic microphone.

According to another aspect, when analyzing, with the system controller, the data collected from each one of the at least one first sensor within each one of the plurality of individual internal sealed chambers and each one of the at least one microphone within each one of the plurality of individual internal sealed chambers, the system controller is further adapted to identify a change in concentration of the test gas within each one of the plurality of individual internal sealed chambers as compared to ambient levels of the test gas, and identify spikes in the sound pressure levels within each one of the plurality of individual internal sealed chambers as compared to ambient sound pressure levels.

According to another aspect, the testing cover is adapted to be applied onto the top surface of the battery tray when the battery tray is supported on an automated guided vehicle (AGV), and the system controller is in communication, via a wireless communication module, with a plurality of AGVs.

According to several aspects of the present disclosure, a method for leak testing a battery tray includes positioning a testing cover onto a top surface of a battery tray, providing, with a flange extending downward from the testing cover, a sealed engagement between the testing cover, and both the top surface of the battery tray and a top surface of an automated guided vehicle (AGV) on which the battery tray is supported and defining an internal sealed chamber and an external sealed chamber therebetween, providing, with a testing gas supply module, in communication with a system controller, pressurized test gas into the external sealed chamber, and at least one of monitoring, with at least one first sensor in communication with the system controller a concentration of the test gas within the internal sealed chamber, and monitoring, with at least one microphone in communication with the system controller a sound pressure level within the internal sealed chamber.

According to another aspect, the providing, with a flange extending downward from the testing chamber, a sealed engagement between the testing cover and both the top surface of the battery tray and a top surface of an automated guided vehicle (AGV) on which the battery tray is supported and defining an internal sealed chamber and an external sealed chamber there-between further includes defining, with the flange, a plurality of testing compartments, and when the flange is in sealed engagement with the top surface of the battery tray, defining, with the flange, a corresponding plurality of individual internal sealed chambers therebetween.

According to another aspect, the monitoring, with at least one first sensor in communication with the system controller a concentration of the test gas within the internal sealed chamber further includes, within each one of the plurality of internal sealed chambers, monitoring, with at least one first sensor in communication with the system controller, a concentration of the test gas therein, and the monitoring, with at least one microphone in communication with the system controller a sound pressure level within the internal sealed chamber further includes, within each one of the plurality of internal sealed chambers, monitoring, with at least one microphone in communication with the system controller, a sound pressure level therein.

According to another aspect, the method further includes providing information to a user of the system via a human machine interface (HMI) in communication with the system controller, and allowing, via the HMI, the user of the system to input information to the system controller.

According to another aspect, the method further includes, with the system controller, collecting data from each one of the at least one first sensor within each one of the plurality of individual internal sealed chambers, collecting data from each one of the at least one microphone within each one of the plurality of individual internal sealed chambers, analyzing the data collected from each one of the at least one first sensor within each one of the plurality of individual internal sealed chambers and each one of the at least one microphone within each one of the plurality of individual internal sealed chambers, and identifying leaks within each one of the individual internal sealed chambers and a specific location of each detected leak based on the data from each one of the at least one first sensor within each one of the plurality of individual internal sealed chambers and each one of the at least one microphone within each one of the plurality of individual internal sealed chambers.

According to another aspect, the monitoring, within each one of the plurality of internal sealed chambers, with at least one first sensor in communication with the system controller, a concentration of the test gas therein further includes monitoring, within each one of the plurality of internal sealed chambers, with at least one photoacoustic spectrometry carbon-dioxide (PAS CO2) sensor in communication with the system controller, a concentration of the test gas therein, and the providing, with a testing gas supply module, in communication with a system controller, pressurized test gas into the external sealed chamber further includes providing, with the testing gas supply module, in communication with the system controller, pressurized carbon dioxide gas into the external sealed chamber.

According to another aspect, the monitoring, within each one of the plurality of sealed chambers, with at least one microphone in communication with the system controller, a sound pressure level therein further includes monitoring, within each one of the plurality of internal sealed chambers, with at least one ultrasonic microphone in communication with the system controller, a sound pressure level therein.

According to another aspect, the analyzing, with the system controller, the data collected from each one of the at least one first sensor within each one of the plurality of individual internal sealed chambers and each one of the at least one microphone within each one of the plurality of individual internal sealed chambers further includes identifying, with the system controller, a change in concentration of the test gas within each one of the plurality of individual internal sealed chambers as compared to ambient levels of the test gas, and identifying, with the system controller, spikes in the sound pressure levels within each one of the plurality of individual internal sealed chambers as compared to ambient sound pressure levels.

According to another aspect, the positioning the testing cover onto the top surface of the battery tray further includes supporting the battery tray on an automated guided vehicle (AGV), and communicating, with the system controller, via a wireless communication module, with the AGV.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a system for leak testing a battery tray in accordance with an exemplary embodiment of the present disclosure;

FIG. 2 is a schematic diagram of the system shown in FIG. 1;

FIG. 3 is a schematic view of a testing cover of the system of the present disclosure in spatial proximity to a battery tray;

FIG. 4 is a schematic perspective view of the testing cover sealed against a top surface of the battery tray;

FIG. 5 is a sectional view taken along line “FIG. 5-FIG. 5” in FIG. 4; and

FIG. 6 is flow chart illustrating a method according to an exemplary embodiment of the present disclosure.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges.

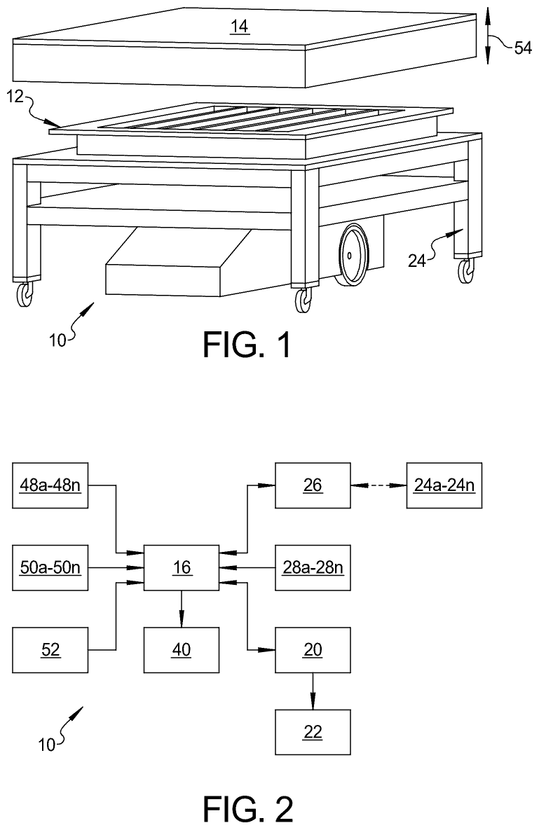

Example embodiments will now be described more fully with reference to the accompanying drawings. In accordance with an exemplary embodiment, FIG. 1 and FIG. 2 shows a system 10 for leak testing a battery tray 12 for a battery. The system 10 includes a testing cover 14 adapted to be positioned, by a system controller 16, onto a top surface 18 of the battery tray 12. In an exemplary embodiment, the system 10 includes an actuator 20 in communication with the system controller 16 and adapted to actuate a lifting mechanism 22 to raise or lower the testing cover 14 based on commands received from the system controller 16, as indicated by arrow 54.

The system controller 16 is non-generalized, electronic control device having at least one processor and a computer readable storage device or media. The at least one data processor can be any custom made or commercially available processor, a central processing unit (CPU), a graphics processing unit (GPU), an auxiliary processor among several processors associated with the system controller 16, a semi-conductor based microprocessor (in the form of a microchip or chip set), a macro-processor, any combination thereof, or generally any device for executing instructions. The computer readable storage device or media may include volatile and nonvolatile storage in read-only memory (ROM), random-access memory (RAM), and keep-alive memory (KAM), for example. KAM is a persistent or non-volatile memory that may be used to store various operating variables while the at least one data processor is powered down. The computer-readable storage device or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the system controller 16 in controlling the system 10.

Although only one system controller 16 is shown in FIG. 2, embodiments of the system 10 can include any number of controllers that communicate over any suitable communication medium or a combination of communication mediums and that cooperate to process sensor signals, perform logic, calculations, methods, and/or algorithms, and generate control signals to automatically control features of the system 10.

In an exemplary embodiment, the battery tray 12 is supported on an automated guided vehicle (AGV) 24 that is adapted to support the battery tray 12 and transport the battery tray 12 to and from various locations, including, in operational proximity to the testing cover 14. The AGV 24, autonomously delivers the battery tray 12 to a testing location where the testing cover 14 can be lowered onto the top surface 18 of the battery tray 12.

In another exemplary embodiment, the system 10 includes a wireless communication module 26 that enables wireless communication between the system controller 16 and a plurality of AGVs 24a-24n. In this way, the system controller 16 can continuously communicate with the plurality of AGVs 24a-24n, and direct the plurality of AGVs 24a-24n to manage an assembly-line-like leak testing process for battery trays 12. For example, the system controller 16, upon completion of leak testing of a first battery tray 12 can send instructions to the AGV 24a-24n transporting the first battery tray 12, directing the AGV 24A-24 to take the first battery tray 12 away to the next stage of manufacturing of the battery, and simultaneously send instructions to a different AGV 24a-24n that is transporting a second battery tray 12, directing that AGV 24a-24n to bring the second battery tray 12 to a position for leak testing.

The wireless communication module 26 is configured to wirelessly communicate information to and from the system controller 16, the plurality of AGVs 24a-24n, other system controllers of parallel leak testing systems, other infrastructure sub-systems, remote systems, remote servers, cloud computers, and/or personal devices. In an exemplary embodiment, the wireless communication module 26 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels.

The system 10 includes a plurality of sensors 28a-28n in communication with the system controller 16. The plurality of sensors 28a-28n are adapted to gather data and monitor conditions of the system 10, including, monitoring the location of a battery tray 12 to be tested relative to the testing cover 14. Referring again to FIG. 1, when an AGV 24a-24n transports a battery tray 12 under the testing cover 14, different ones of the plurality of sensors 28a-28n gather data and images to determine the exact position of the battery tray 12 relative to the testing cover 14, and, if necessary, send instructions to the AGV 24a-24n, directing the AGV 24a-24n to reposition itself and the battery tray 12.

The plurality of sensors 28a-28n sense observable conditions of the system 10 and the environment surrounding the system 10. The plurality of sensors 28a-28n can include, but are not limited to, radars, lidars, global positioning systems, optical cameras, thermal cameras, ultrasonic sensors, and/or other sensors. The cameras can include two or more digital cameras spaced at a selected distance from each other, in which the two or more digital cameras are used to obtain stereoscopic images of the surrounding environment in order to obtain a three-dimensional image.

The testing cover 14 includes a flange 30 extending downward from the testing cover 14 and adapted to provide a sealed engagement between the testing cover 14 and both the top surface 18 of the battery tray 12 and the AGV 24 when the testing cover 14 is positioned onto the top surface 18 of the battery tray 12, thereby defining an internal sealed chamber 32 between the testing cover and the battery tray, and an external sealed chamber 33 within the flange 30 and surrounding the battery tray 12.

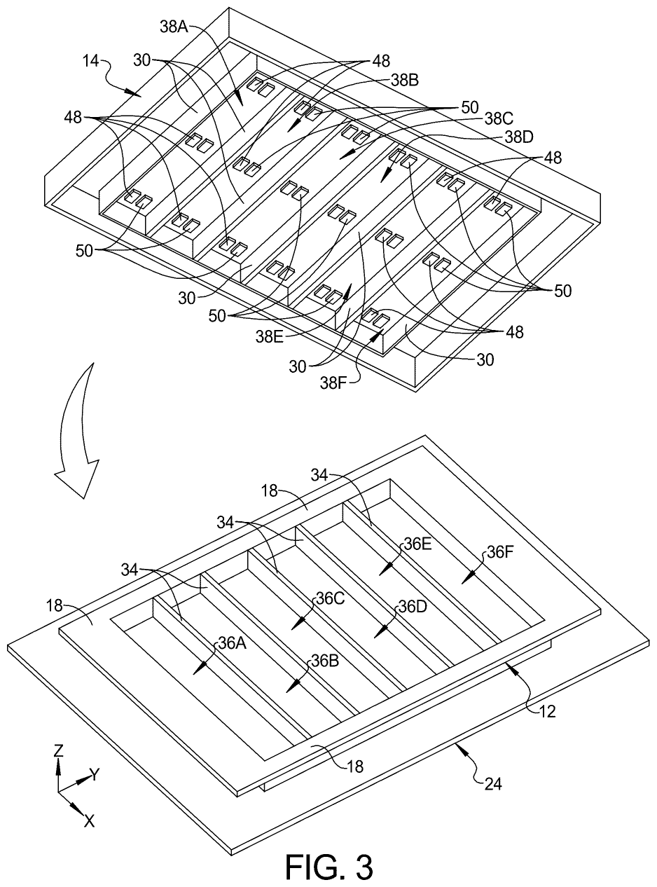

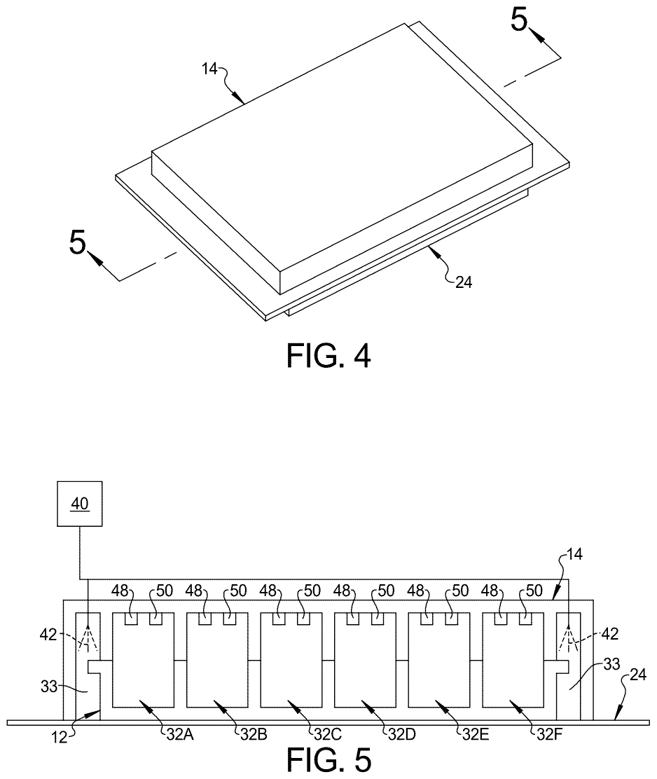

Referring to FIG. 3, the battery tray 12 includes structural cross-members 34 that span across the entire width of the battery pack tray 12 along an X-direction as shown, dividing the battery tray 12 into a plurality of sections or modules 36A-36F. Each section or module 36A-36F will house a portion of the battery cells of the battery therein. As shown, and by way of non-limiting example, the battery tray 12 includes five structural cross members 34 that divide the battery tray 12 into six individual modules 36A-36F. For accurate identification and location of leaks within the battery tray 12, it is desirable to independently test different regions within the battery tray 12. In an exemplary embodiment, the flange 30 defines a plurality of testing compartments 38A-38F, as shown in FIG. 3. The testing compartments 38A-38F correspond to the modules 36A-36F of the battery tray 12, such that when the flange 30 is in sealed engagement with the top surface 18 of the battery tray 12, as shown in FIG. 4, the flange 30 defines a corresponding plurality of individual internal sealed chambers 32A-32F therebetween, as shown in FIG. 5.

Referring again to FIG. 2, the system 10 includes a testing gas supply module 40, in communication with the system controller 16 and adapted to provide pressurized test gas 42 into the external sealed chamber 33. The testing gas supply module 40 provides gas to the external sealed chamber 33 created by the flange 30 that extends down from the testing cover 14 and that seals against the top surface of the AGV 24 and the top surface 18 of the battery tray 12. In an exemplary embodiment, the testing gas 42 is carbon dioxide and the testing gas supply module 40 is adapted to supply pressurized carbon dioxide 42 to the external sealed cavity 33 created by the flange 30 extending down from the testing cover 14 that seals against the top of the AGV 24 and the top surface 18 of the battery tray 12. Once the testing tray 14 is lowered onto the top surface 18 of the battery tray 12 and the flange 30 is in sealed engagement with the top surface 18 of the battery tray 12, the testing gas supply module 40 pumps pressurized carbon dioxide gas 42 into the external sealed chamber 33 created by the flange 30 extending down from the testing cover 14 that seals against the top of the AGV 24 and the top surface 18 of the battery tray 12.

Once pressurized test gas 42 is pumped into the external sealed chamber 33 created by the flange 30 extending down from the testing cover 14 that seals against the top of the AGV 24 and the top surface 18 of the battery tray 12, the system 10 is adapted to monitor each of the individual internal sealed chambers 32A-32F to identify the presence of any leaks in the battery tray 12 and the specific location of any such leaks. In an exemplary embodiment, each one of the testing compartments 38A-38F of the testing cover 14 includes at least one of 1) at least one first sensor 48 in communication with the system controller 16 and adapted to monitor a concentration of the test gas 42 within a correspond one of the plurality of individual internal sealed chambers 32A-32F, and/or 2) at least one microphone 50 in communication with the system controller 16 and adapted to monitor a sound pressure level within a corresponding one of the plurality of individual internal sealed chambers 32A-32F.

In an exemplary embodiment, each one of the at least one first sensor 48 within each one of the plurality of individual internal sealed chambers 32A-32F is a photoacoustic spectrometry carbon-dioxide (PAS CO2) sensor adapted to monitor a concentration of the pressurized carbon dioxide gas within each one of the individual internal sealed chambers 32A-32F. Photoacoustic Spectroscopy CO2 Sensors (PAS CO2 sensor) employ photoacoustic spectroscopy. The PAS CO2 sensor 48 modulates light based on Lambert-Beer's law, causing the targeted gas molecules to undergo pulsation and generate acoustic vibrations. These acoustic vibrations at particular frequencies reveal the carbon dioxide levels. This technique of measuring carbon dioxide concentrations is capable of measuring CO2 concentrations from 0 to 32,000 ppm with an accuracy of ±(30 ppm+3%), and thus providing high sensitivity and accuracy. Further, PAS CO2 sensors are compact.

In another exemplary embodiment, each one of the at least one microphone 50 within each one of the plurality of individual internal sealed chambers is an ultrasonic microphone. Sound Pressure Level (SPL) indicates the intensity of ultrasonic sound, measured in decibels (dB). To measure SPL the ultrasonic microphone 50 is placed at a fixed distance from the source and a sound level meter or a spectrum analyzer records the pressure levels, accounting for environmental factors, like temperature and humidity, which can affect ultrasonic propagation. Ultrasonic waves are characterized by their high frequency and short wavelength. These attributes allow the sound waves to travel through solid materials and fluids with minimal attenuation. However, they are also highly directional, which means they require precise positioning of detection equipment for accurate measurement.

The system controller 16 is adapted to collect data from each one of the at least one first sensor 48 (PAC CO2 sensor) within each one of the plurality of individual internal sealed chambers 32A-32F, collect data from each one of the at least one microphone 50 (ultrasonic microphone) within each one of the plurality of individual internal sealed chambers 32A-32F, analyze the data collected from each one of the at least one first sensor 48 within each one of the plurality of individual internal sealed chambers 32A-32F and each one of the at least one microphone 50 within each one of the plurality of individual internal sealed chambers 32A-32F, and identify leaks within each one of the individual internal sealed chambers 32A-32F and a specific location of each detected leak based on the data collected from each one of the at least one first sensor 48 within each one of the plurality of individual internal sealed chambers 32A-32F and each one of the at least one microphone 50 within each one of the plurality of individual internal sealed chambers 32A-32F.

The system controller 16 identifies any change in concentration of the test gas 42 within each one of the plurality of individual internal sealed chambers 32A-32F as compared to ambient levels of the test gas 42, and identifies spikes in the sound pressure levels within each one of the plurality of individual internal sealed chambers 32A-32F as compared to ambient sound pressure levels, either of which will be present upon leakage of pressurized gas from the external sealed chamber 33 into one of the plurality of internal sealed chambers 32A-32F. By having multiple PAS CO2 sensors 48 and multiple ultrasonic microphones 50 within each of the individual internal sealed chambers 32A-32F, the system controller 16 can identify which of the individual internal sealed chambers 32A-32F has a leak, correlating to a leak in the module 36A-36F of the battery tray 12 corresponding to the individual internal sealed chamber 32A-32F wherein the leak was detected. Each of the individual internal sealed chambers 32A-32F includes at least one PAS CO2 sensor 48 and/or at least one ultrasonic microphone 50. Greater accuracy of leak detection is achieved by using multiple of each sensor 48, 50 within each of the plurality of individual internal sealed chambers 32A-32F.

More than one PAS CO2 sensor 48 will provide more accurate and faster detection of a leak. More than one PAS CO2 sensor 48 and more than one ultrasonic microphone 50 will provide more accurate determination of the specific location of a detected leak. By having an array of multiple ones of both PAS CO2 sensors 48 and ultrasonic microphones 50 within each one of the individual internal sealed chambers 32A-32F, it is more likely that a PAS CO2 sensor 48 is within close proximity to a leak, providing faster detection of a fluctuation in the carbon dioxide concentration and, thus, faster detection of the leak. Further, by identifying which of the array of PAS CO2 sensors 48 detected the leak, an initial location of the leak can be determined. Finally, the directional nature of ultrasonic sound waves made by a leak, aid in pin-pointing the exact location of the leak by analyzing which of the multiple ultrasonic microphones 50 were more precisely oriented relative to the detected ultrasonic sound waves.

Referring again to FIG. 3, as shown, each of the testing compartments 38A-38F includes three PAS CO2 sensors 48 and three ultrasonic microphones 50. It should be understood by those skilled in the art that any number of each may be used. Dividing the battery tray 12 into several regions, and the internal sealed chamber 32 into a plurality of individual internal sealed chambers 32A-32F provides more accurate identification of the presence and location of detected leaks. By using an array 48a-48n of multiple PAS CO2 sensors 48 and an array 50a-50n of multiple ultrasonic microphones 50, even more accurate identification of the presence and location of detected leaks can be achieved. The higher the number of PAS CO2 sensors 48 and/or ultrasonic microphones 50 used, the faster and more accurate leak detection and location will be.

In another exemplary embodiment, the system 10 includes a human machine interface (HMI) 52 in communication with the system controller 16 and adapted to provide information to a user of the system 10 and to allow the user of the system 10 to provide input to the system controller 16. The HMI 52 may be used by an operator of the system 10 to input testing parameters, or set thresholds for alarms. The system controller 16, when leaks are detected may either provide an alarm and/or message to an operator, via the HMI 52, or alternatively, in a fully automated production mode, direct the AGV 24 that is carrying the battery tray 12 wherein a leak has been detected to transport the battery tray 12 to a location for further inspection and/or repair. Thus, the system of the present disclosure, automatically detects the leak, identifies the location of the leak, for which information can be electronically attached to the battery tray 12 for use later when the battery tray is inspected/repaired. Further, the system 10, upon no detection of leaks, may automatically direct the AGV 24 to transport the battery tray 12 on to the next phase of manufacture of a battery.

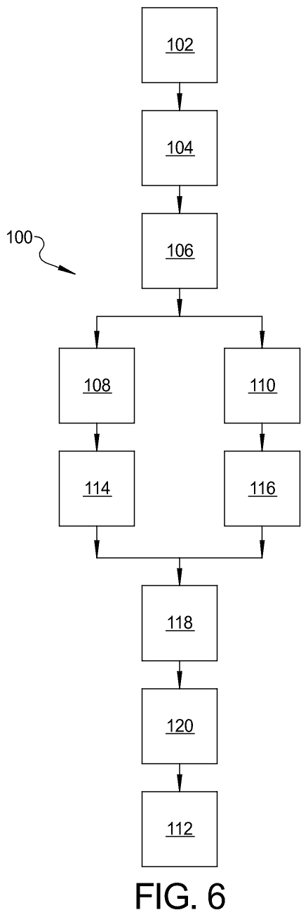

Referring to FIG. 6, a method 100 for leak testing a battery tray 12 includes, beginning at block 102, positioning a testing cover 14 onto a top surface 18 of a battery tray 12, moving to block 104, providing, with a flange 30 extending downward from the testing cover 14, a sealed engagement between the testing cover 14 and both the top surface 18 of the battery tray 12 and an AGV 24 onto which the battery tray 12 is supported, and defining an internal sealed chamber 32 and an external sealed chamber 33 therebetween, moving to block 106, providing, with a testing gas supply module 40, in communication with a system controller 16, pressurized test gas 42 into the external sealed chamber 33, and, at least one of, moving to block 108, monitoring, with at least one first sensor 48 in communication with the system controller 16 a concentration of the test gas 42 within the internal sealed chamber 32, and, moving to block 110, monitoring, with at least one microphone 50 in communication with the system controller 16 a sound pressure level within the internal sealed chamber 32.

In another exemplary embodiment, the providing, with a flange 30 extending downward from the testing chamber 14, a sealed engagement between the testing cover 14 and the top surface 18 of the battery tray 12 and the AGV 24, defining an internal sealed chamber 32 and an external sealed chamber 33 therebetween at block 104, further includes defining, with the flange 30, a plurality of testing compartments 38A-38F, and, when the flange 30 is in sealed engagement with the top surface 18 of the battery tray 12, defining, with the flange 30, a corresponding plurality of individual internal sealed chambers 32A-32F therebetween.

In another exemplary embodiment, the monitoring, with at least one first sensor 48 in communication with the system controller 16 a concentration of the test gas 42 within the internal sealed chamber 32A-32F at block 108 further includes, within each one of the plurality of internal sealed chambers 32A-32F, monitoring, with at least one first sensor 48 in communication with the system controller 16, a concentration of the test gas 42 therein, and the monitoring, with at least one microphone 50 in communication with the system controller 16 a sound pressure level within the internal sealed chamber 32 at block 110 further includes, within each one of the plurality of internal sealed chambers 32A-32F, monitoring, with at least one microphone 50 in communication with the system controller 16, a sound pressure level therein.

In another exemplary embodiment, the method 100 further includes, moving to block 112, providing information to a user of the system 10 via a human machine interface (HMI) 52 in communication with the system controller 16, and allowing, via the HMI 52, the user of the system 10 to input information to the system controller 16.

In another exemplary embodiment, the method 100 further includes, moving from block 108 to block 114, collecting data from each one of the at least one first sensor 48 within each one of the plurality of individual internal sealed chambers 32A-32F, moving from block 110 to block 116, collecting data from each one of the at least one microphone 50 within each one of the plurality of individual internal sealed chambers 32A-32F, moving from blocks 114 and 116 to block 118, analyzing the data collected from each one of the at least one first sensor 48 within each one of the plurality of individual internal sealed chambers 32A-32F and each one of the at least one microphone 50 within each one of the plurality of individual internal sealed chambers 32A-32F, and, moving to block 120, identify leaks within each one of the individual internal sealed chambers and a specific location of each detected leak based on the data from each one of the at least one first sensor within each one of the plurality of individual internal sealed chambers and each one of the at least one microphone within each one of the plurality of individual internal sealed chambers.

In another exemplary embodiment, the monitoring, within each one of the plurality of sealed chambers 32A-32F, with at least one first sensor 48 in communication with the system controller 16, a concentration of the test gas 42 therein at block 108 further includes monitoring, within each one of the plurality of internal sealed chambers 32A-32F, with at least one photoacoustic spectrometry carbon-dioxide (PAS CO2) sensor 48 in communication with the system controller 16, a concentration of the test gas 42 therein, and, the providing, with a testing gas supply module 40, in communication with a system controller 16, pressurized test gas 42 into the external sealed chamber 33 at block 106 further includes providing, with the testing gas supply module 40, in communication with the system controller 16, pressurized carbon dioxide gas into the external sealed chamber 33.

In another exemplary embodiment, the monitoring, within each one of the plurality of internal sealed chambers 32A-32F, with at least one microphone 50 in communication with the system controller 16, a sound pressure level therein at block 110 further includes monitoring, within each one of the plurality of internal sealed chambers 32A-32F, with at least one ultrasonic microphone 50 in communication with the system controller 16, a sound pressure level therein.

In another exemplary embodiment, the analyzing, with the system controller 16, the data collected from each one of the at least one first sensor 48 within each one of the plurality of individual internal sealed chambers 32A-32F and each one of the at least one microphone 50 within each one of the plurality of individual internal sealed chambers 32A-32F at block 118 further includes identifying, with the system controller 16, a change in concentration of the test gas 42 within each one of the plurality of individual internal sealed chambers 32A-32F as compared to ambient levels of the test gas 42, and, identifying, with the system controller 16, spikes in the sound pressure levels within each one of the plurality of individual internal sealed chambers 32A-32F as compared to ambient sound pressure levels.

In another exemplary embodiment, the positioning the testing cover 14 onto the top surface 18 of the battery tray 12 at block 102 further includes supporting the battery tray 12 on an automated guided vehicle (AGV) 24, and communicating, with the system controller 16, via a wireless communication module 26, with the AGV 24.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for leak testing a battery tray, comprising:
a system controller;
a testing cover adapted to be positioned, by the system controller, onto a top surface of a battery tray;
a flange extending downward from the testing cover and adapted to provide a sealed engagement between the testing cover and the top surface of the battery tray and a top surface of an automated guided vehicle (AGV) on which the battery tray is supported when the testing cover is positioned onto the top surface of the battery tray, thereby defining an internal sealed chamber and an external sealed chamber therebetween;
a testing gas supply module, in communication with the system controller and adapted to provide pressurized test gas into the external sealed chamber; and
at least one of:
at least one first sensor in communication with the system controller and adapted to monitor a concentration of the test gas within the internal sealed chamber; and
at least one microphone in communication with the system controller and adapted to monitor a sound pressure level within the internal sealed chamber.

2. The system of claim 1, wherein the flange defines a plurality of testing compartments and when the flange is in sealed engagement with the top surface of the battery tray, the flange defines a corresponding plurality of individual internal sealed chambers therebetween.

3. The system of claim 2, wherein each one of the plurality of testing compartments includes at least one of:
at least one first sensor in communication with the system controller and adapted to monitor a concentration of the test gas within a corresponding one of the plurality of individual internal sealed chambers; and
at least one microphone in communication with the system controller and adapted to monitor a sound pressure level within a corresponding one of the plurality of individual internal sealed chambers.

4. The system of claim 3, further including a human machine interface (HMI) in communication with the system controller and adapted to provide information to a user of the system and to allow the user of the system to provide input to the system controller.

5. The system of claim 4, wherein the system controller is adapted to:
collect data from each one of the at least one first sensor within each one of the plurality of individual internal sealed chambers;
collect data from each one of the at least one microphone within each one of the plurality of individual internal sealed chambers;
analyze the data collected from each one of the at least one first sensor within each one of the plurality of individual internal sealed chambers and each one of the at least one microphone within each one of the plurality of individual internal sealed chambers; and
identify leaks within each one of the individual internal sealed chambers and a specific location of each detected leak based on the data collected from each one of the at least one first sensor within each one of the plurality of individual internal sealed chambers and each one of the at least one microphone within each one of the plurality of individual internal sealed chambers.

6. The system of claim 5, wherein each one of the at least one first sensor within each one of the plurality of individual internal sealed chambers is a photoacoustic spectrometry carbon-dioxide (PAS CO2) sensor and the test gas is carbon-dioxide gas.

7. The system of claim 5, wherein each one of the at least one microphone within each one of the plurality of individual internal sealed chambers is an ultrasonic microphone.

8. The system of claim 5, wherein, when analyzing, with the system controller, the data collected from each one of the at least one first sensor within each one of the plurality of individual internal sealed chambers and each one of the at least one microphone within each one of the plurality of individual internal sealed chambers, the system controller is further adapted to:
identify a change in concentration of the test gas within each one of the plurality of individual internal sealed chambers as compared to ambient levels of the test gas; and
identify spikes in the sound pressure levels within each one of the plurality of individual internal sealed chambers as compared to ambient sound pressure levels.

9. The system of claim 5, wherein the testing cover is adapted to be applied onto the top surface of the battery tray when the battery tray is supported on an automated guided vehicle (AGV), and the system controller is in communication, via a wireless communication module, with a plurality of AGVs.

10. A method for leak testing a battery tray, comprising:
positioning a testing cover onto a top surface of a battery tray;
providing, with a flange extending downward from the testing cover, a sealed engagement between the testing cover, and both the top surface of the battery tray and a top surface of an automated guided vehicle (AGV) on which the battery tray is supported and defining an internal sealed chamber and an external sealed chamber therebetween;
providing, with a testing gas supply module, in communication with a system controller, pressurized test gas into the external sealed chamber; and
at least one of:
monitoring, with at least one first sensor in communication with the system controller a concentration of the test gas within the internal sealed chamber; and
monitoring, with at least one microphone in communication with the system controller a sound pressure level within the internal sealed chamber.

11. The method of claim 10, wherein the providing, with a flange extending downward from the testing chamber, a sealed engagement between the testing cover and both the top surface of the battery tray and a top surface of an automated guided vehicle (AGV) on which the battery tray is supported and defining an internal sealed chamber and an external sealed chamber there-between further includes:
defining, with the flange, a plurality of testing compartments; and
when the flange is in sealed engagement with the top surface of the battery tray, defining, with the flange, a corresponding plurality of individual internal sealed chambers therebetween.

12. The method of claim 11, wherein:
the monitoring, with at least one first sensor in communication with the system controller a concentration of the test gas within the internal sealed chamber further includes, within each one of the plurality of internal sealed chambers, monitoring, with at least one first sensor in communication with the system controller, a concentration of the test gas therein; and
the monitoring, with at least one microphone in communication with the system controller a sound pressure level within the internal sealed chamber further includes, within each one of the plurality of internal sealed chambers, monitoring, with at least one microphone in communication with the system controller, a sound pressure level therein.

13. The method of claim 12, further including:
providing information to a user of the system via a human machine interface (HMI) in communication with the system controller; and
allowing, via the HMI, the user of the system to input information to the system controller.

14. The method of claim 13, further including, with the system controller:
collecting data from each one of the at least one first sensor within each one of the plurality of individual internal sealed chambers;
collecting data from each one of the at least one microphone within each one of the plurality of individual internal sealed chambers;
analyzing the data collected from each one of the at least one first sensor within each one of the plurality of individual internal sealed chambers and each one of the at least one microphone within each one of the plurality of individual internal sealed chambers; and
identifying leaks within each one of the individual internal sealed chambers and a specific location of each detected leak based on the data from each one of the at least one first sensor within each one of the plurality of individual internal sealed chambers and each one of the at least one microphone within each one of the plurality of individual internal sealed chambers.

15. The method of claim 14, wherein:
the monitoring, within each one of the plurality of internal sealed chambers, with at least one first sensor in communication with the system controller, a concentration of the test gas therein further includes monitoring, within each one of the plurality of internal sealed chambers, with at least one photoacoustic spectrometry carbon-dioxide (PAS CO2) sensor in communication with the system controller, a concentration of the test gas therein; and
the providing, with a testing gas supply module, in communication with a system controller, pressurized test gas into the internal sealed chamber further includes providing, with the testing gas supply module, in communication with the system controller, pressurized carbon dioxide gas into each one of the plurality of individual internal sealed chambers.

16. The method of claim 14 wherein the monitoring, within each one of the plurality of internal sealed chambers, with at least one microphone in communication with the system controller, a sound pressure level therein further includes monitoring, within each one of the plurality of internal sealed chambers, with at least one ultrasonic microphone in communication with the system controller, a sound pressure level therein.

17. The method of claim 14, wherein, the analyzing, with the system controller, the data collected from each one of the at least one first sensor within each one of the plurality of individual internal sealed chambers and each one of the at least one microphone within each one of the plurality of individual internal sealed chambers further includes:
identifying, with the system controller, a change in concentration of the test gas within each one of the plurality of individual internal sealed chambers as compared to ambient levels of the test gas; and
identifying, with the system controller, spikes in the sound pressure levels within each one of the plurality of individual internal sealed chambers as compared to ambient sound pressure levels.

18. The method of claim 14, wherein the positioning the testing cover onto the top surface of the battery tray further includes:
supporting the battery tray on an automated guided vehicle (AGV); and
communicating, with the system controller, via a wireless communication module, with the AGV.

19. A system for leak testing a battery tray, comprising:
a system controller;
a testing cover adapted to be positioned, by the system controller, onto a top surface of a battery tray and a top surface of an automated guided vehicle (AGV) on which the battery tray is supported;
a flange extending downward from the testing cover and defining a plurality of testing compartments and adapted to provide a sealed engagement between the testing cover and the top surface of the battery tray and the top surface of the AGV when the testing cover is positioned onto the top surface of the battery tray, wherein the plurality of testing compartments defines a corresponding plurality of individual internal sealed chambers and the flange further defines an external sealed chamber;
a testing gas supply module, in communication with the system controller and adapted to provide pressurized carbon dioxide gas into the external sealed chamber; and
each one of the plurality of testing compartments including at least one of:
at least one photoacoustic spectrometry carbon dioxide (PAS CO2) sensor in communication with the system controller and adapted to monitor a concentration of the test gas within a corresponding one of the plurality of individual internal sealed chambers; and
at least one ultrasonic microphone in communication with the system controller and adapted to monitor a sound pressure level within a corresponding one of the plurality of individual internal sealed chambers;
the system controller further adapted to:
collect data from each one of the at least one PAS CO2 sensor within each one of the plurality of individual internal sealed chambers;
collect data from each one of the at least one ultrasonic microphone within each one of the plurality of individual internal sealed chambers;
analyze the data collected from each one of the at least one PAS CO2 sensor within each one of the plurality of individual internal sealed chambers and each one of the at least one ultrasonic microphone within each one of the plurality of individual internal sealed chambers; and
identify leaks within each one of the individual internal sealed chambers and a specific location of each detected leak.

20. The system of claim 19, further including a human machine interface (HMI) in communication with the system controller and adapted to provide information to a user of the system and to allow the user of the system to provide input to the system controller; and
further wherein, the testing cover is adapted to be applied onto the top surface of the battery tray when the battery tray is supported on an automated guided vehicle (AGV), and the system controller is in communication, via a wireless communication module, with a plurality of AGVs.
